(19) United States
(12) Patent Application Publication
(10) Pub. No.: US 2007/0099528 A1
(43) Pub. Date: May 3, 2007

(54) Reinforced multilayer material and protective wear made therefrom

(75) Inventors: Nathaniel H. Kolmes, Hickory, NC (US); Fred Elton Driver, Ronda, NC (US); Walter Gordon Schulein, Little Egg Harbor, NJ (US); Lynn J. Bell, Lincoln University, PA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: Supreme Elastic Corporation, Conover, NC (US)

(21) Appl. No.: 11/263,851

(22) Filed: Nov. 2, 2005

(51) Int. Cl. B32B 5/26; D03D 15/00; B29D 22/00; B32B 1/08

(52) U.S. Cl. 442/189; 442/190; 442/191; 442/197; 442/239; 442/243; 442/246; 442/255; 442/260; 442/268; 442/301; 428/908.8; 428/36.1

(57) ABSTRACT

A reinforced multilayer material is provided wherein the reinforced multilayer material contains an exterior layer having an exterior side and an interior side; and a first interior layer affixed to the interior side of the exterior layer, wherein the first interior layer is made of at least a fabric formed form one or more composite yarns and is light-weight, cut and/or abrasion resistant, and permits air and water vapor to flow therethrough, protective wear made from the reinforced multilayer material and container articles having the reinforced multilayer material as a protective covering.

### BACKGROUND OF THE INVENTION

1. Field of the Invention

The present invention relates to a multilayer material that is reinforced to provide cut and/or abrasion resistance, and the use of that material in providing various items of protective wear.

2. Discussion of the Related Art

In many industries and professions there is a need for protective wear that is cut and/or abrasion resistant, yet lightweight and comfortable for the wearer. From maintenance workers crawling through HVAC ventilation shafts to weekend warriors participating in various sporting events to police officers having to confront knife wielding assailants, many individuals need protection from cuts and scrapes as they go about their daily activities.

However, previously proposed protective garments often suffer from numerous disadvantages. The garments are often unsightly, unable to provide a satisfactory level of protection to a wearer of the garment, are easily damaged, are unwieldy and uncomfortable to the wearer, do not permit airflow therethrough, do not permit the escape of excess water vapor from the skin of the wearer, and often require the use of specialized over- or undergarments.

Thus there is a need for a comfortable material having a appealing appearance, while providing cut and/or abrasion resistance to the wearer, or if used as a covering for an article, providing a tough, cut and/or abrasion resistance cover. Further, there is a need for such material to be flexible, and comfortable.

### SUMMARY OF THE INVENTION

It is an object of the present invention to overcome these or other disadvantages of known protective materials.

It is a further object of the present invention to provide a multilayer material that has an appealing outer appearance, while providing adequate cut and/or abrasion resistance in use.

It is a further object of the present invention to provide a leather garment, such as a leather glove, leather jacket, leather pants or leather jumpsuit, made of the multilayer material, wherein the outer layer is leather.

It is a further object of the present invention to provide an article made of the multilayer material, such as a piece of luggage, which has an appealing outer layer, such as leather or vinyl, while providing cut and/or abrasion resistance, thus protecting the contents.

These and other objects of the present invention can be provided by a reinforced multilayer material comprising an outer layer, preferably configured to resist damage, a first interior layer comprising a fabric made from a composite cut and abrasion resistant yarn and being light-weight, resistant to damage, and permitting air and water vapor to flow therethrough, and optionally a second interior layer, wherein the first interior layer is between the exterior layer and the second interior layer, and a protective garment, such as a glove, vest, jacket or jumpsuit made therefrom, and a container article, such as a piece of luggage or handbag (including the handbag strap), made therefrom.

The present invention can further provide a method of protecting a hand of a wearer of a glove from injury, using the glove of the present invention. The method includes disposing a first interior layer of the glove directly in contact with the hand of the wearer, the first interior layer including a light-weight, cut and/or abrasion resistant material able to prevent injuries to the wearer of the glove, and disposing an outer layer above the first interior layer, the outer layer providing resistance to damage to lesser extent than the first interior layer. In a further embodiment, the method can further comprise disposing a second interior layer between the hand of the wearer and the first interior layer for added comfort and feel.

The present invention further can provide a cut and abrasion resistant leather garment, in the form of a jacket, vest or pants, comprising an outer leather layer, and an inner layer of a fabric formed of a cut and abrasion resistant composite yarn affixed to the inner surface of the outer leather layer, optionally including a further inner lining layer.

### DETAILED DESCRIPTION OF THE INVENTION

The present invention relates to a multilayer material, wherein an exterior layer of the material provides one or more advantages such as damage resistance, nice appearance, desired color, etc., while a first interior layer comprises a cut and/or abrasion resistant fabric made from at least one cut and/or abrasion resistant yam, which may be assembled in any manner. Suitable cut and/or abrasion resistant fabrics include woven, knit and non-woven fabrics. Suitable composite yarns which may be used to prepare the cut and/or abrasion resistant fabric include, but are not limited to, those as described in U.S. Pat. No. 4,777,789, U.S. Pat. No. 4,838,017, U.S. Pat. No. 4,936,085, U.S. Pat. No. 5,177,948, U.S. Pat. No. 5,628,172, U.S. Pat. No. 5,632,137, U.S. Pat. No. 5,644,907, U.S. Pat. No. 5,655,358, U.S. Pat. No. 5,845,476, U.S. Pat. No. 6,212,914, U.S. Pat. No. 6,230,524, U.S. Pat. No. 6,341,483, U.S. Pat. No. 6,349,531, U.S. Pat. No. 6,363,703, U.S. Pat. No. 6,367,290, and U.S. Pat. No. 6,381,940, the contents of each of which are hereby incorporated by reference. Each of the patents disclose composite yarns and fabrics that are well suited for use in the cut and/or abrasion resistant fabric of the first interior layer disclosed herein. Each of these composite yams is one or more of strong, light-weight, easily woven into a fabric, resistant to damage, able to permit air and water vapor flow, and able to prevent or decrease the seriousness of an injury from cuts or abrasions to a portion of the body of the wearer covered by the fabric.

The multilayer material of the present invention may comprise one or more additional interior layers, either between the first interior layer and the exterior layer, on a side of the first interior layer away from the exterior layer, or both. These additional interior layers may be made of any desired material, including, but not limited to, fabrics from natural or synthetic fibers, such as cotton, rayon, silk, polyester, and nylon, animal hides and furs, and even polymers such as latex.

In a preferred embodiment of the present invention, the exterior layer is preferably a material that can be readily dyed and formed into a garment or covering for a container article, such as a piece of luggage or handbag, including the handbag strap. More preferred materials for the exterior layer include animal hides, vinyl, and fabrics made from synthetic or natural fibers such as nylon (particularly ballistic nylon), polyester, aramids, cotton, wool, etc. In a most preferred embodiment, the exterior layer comprises animal hide, such as leather.

The multilayer material of the present invention can be used in any form, but is preferably made into a covering for container articles, such as luggage or handbags (optionally including the handbag strap), or made into a garment, such as gloves, a jacket, a vest, pants, and jumpsuits.

In the multilayer material of the present invention, the first interior layer and exterior layer are affixed one to the other, either directly or through an intermediate layer of material. Within the context of the present invention, the term “affixed” can indicate attachment (either directly or indirectly) at a single location or a plurality of locations, up to attachment of the first interior layer to the exterior layer having essentially complete contact and affixation of the sides of the layers which are facing one another. The affixing can be by any method sufficient to avoid disconnection between the layers, and is preferably by stitching the layers together or by use of an adhesive.

The optional one or more additional layers are also preferably affixed to the layer or layers to which they are adjacent by similar techniques. These additional one or more layers are preferably used to provide better feel to the wearer (in the event of a glove or like article of clothing), to provide added warmth, or even to provide waterproofing, as desired. The choice of material used for the one or more additional layers is dependent on the property sought and is readily apparent to one of ordinary skill in the art.

In a further embodiment of the invention, a garment is provided that has an exterior layer, such as leather, with a first interior layer affixed to the underside of the exterior layer, wherein the first interior layer is made from a fabric formed of a cut and abrasion resistant composite yam. An optional second interior layer can be used between the wearer and the first interior layer to provide better comfort and feel if desired. The second interior layer can be made from any desired material, such as silk, cotton, wool, or other typical clothing fibers. The garment can preferably be in the form of a jacket, pants, or jumpsuit, and is particularly suited for high risk activities, such as motorcycle riding or other activities where there is a risk of contact between the wearer and the ground or a sharp object in the event of an accident.

It is noted that in various embodiments of the invention, one or more of the linings or layers can permit the flow of water vapor therethrough, or can permit the flow of air therethrough. By this arrangement, perspiration on the skin of the wearer of the protecting component is permitted to evaporate, or the wearer of the protecting component can be cooled, without removal of the protecting component.

In a preferred embodiment of the present invention, leather gloves having a first interior layer formed of the fabric formed from cut and/or abrasion resistant composite yarn are provided with significantly improved cut resistance. The inventors have found that even drawing of a razor knife across the flattened leather glove made from the multilayer material of the present invention, shows no penetration or cutting of the cut and/or abrasion resistant composite yam fabric, even while the leather exterior layer is slashed open. This test is performed against a hard surface such as a table top, which would be more likely to cause cutting of the fabric made from the composite yarn as compared to passing the razor knife across the glove while being worn by a person, such as a police officer. The cut and abrasion resistance afforded by the multilayer material of the present invention would thus provide an added layer of safety for the wearer, while maintaining desired comfort.

Previous composite yarn based gloves have been proposed in the various patents mentioned above regarding composite yarns. However, these gloves were typically knit directly from the composite yarn, and while providing adequate cut protection, were not aesthetically pleasing, as there was no exterior layer such as required in the present invention, nor was there proposed an optional one or more additional layers for comfort purposes.

Due to the protection afforded by materials used in the exterior layer of the present invention, such as leather or aramids, the first interior layer may be made of composite yarns having smaller overall yarn size, preferably having a composite denier of from 300 to 5000, more preferably from 400 to 4500, including all subranges therein. This allows the cut and/or abrasion resistant layer to be lighter, more flexible and still provide sufficient cut and/or abrasion resistance, particularly in combination with the protective nature of the exterior layer.

Numerous additional modifications and variations of the present invention are possible in light of the above teachings. It is therefore to be understood that within the scope of the appended claims, the present invention may be practiced otherwise than as specifically described herein.

1. A reinforced multilayer material, comprising:
an exterior layer having an exterior side and an interior side;
a first interior layer affixed to said interior side of the exterior layer, said first interior layer comprising a fabric formed form one or more composite yarns and being light-weight, cut and abrasion resistant, and permitting air and water vapor to flow therethrough.

2. The reinforced multilayer material according to claim 1, further comprising a second interior layer, and said second interior layer comprises at least one member selected from the group consisting of latex, animal hides, animal furs, cotton, rayon, silk, polyester, and nylon.

3. The reinforced multilayer material according to claim 1, wherein the exterior layer comprises at least one member selected from the group consisting of animal hides, vinyl, and fabrics made from synthetic or natural fibers.

4. The reinforced multilayer material according to claim 3, wherein the exterior layer comprises leather.

5. The reinforced multilayer material according to claim 3, further comprising a second interior layer, and said second interior layer comprises at least one member selected from the group consisting of latex, animal hides, animal furs, cotton, rayon, silk, polyester, and nylon.

6. The reinforced multilayer material according to claim 4, further comprising a second interior layer, and said second interior layer comprises at least one member selected from the group consisting of latex, animal hides, animal furs, cotton, rayon, silk, polyester, and nylon.

7. The reinforced multilayer material according to claim 1, further comprising at least one adhesive layer adhering at least the exterior layer and first interior layer to one another.

8. The reinforced multilayer material according to claim 5, further comprising at least one adhesive layer adhering two or more of the exterior, first interior and second interior layers to one another.

9. A protective garment, comprising:
an exterior layer configured to resist damage having an exterior side and an interior side;
a first interior layer affixed to said interior side of the exterior layer, said first interior layer comprising a fabric formed from one or more composite yams and being light-weight, cut and abrasion resistant, and permitting air and water vapor to flow therethrough; and
an optional second interior layer interposed between said first interior layer and a a wearer of the protective garment.

10. The protective garment according to claim 9, wherein said garment is a glove, a jacket, a vest, pants or a jumpsuit.

11. The protective garment according to claim 9, wherein the garment comprises said second interior layer, and said second interior layer comprises at least one member selected from the group consisting of latex, animal hides, animal furs, cotton, rayon, silk, polyester, and nylon.

12. The protective garment according to claim 9, wherein the exterior layer comprises at least one member selected from the group consisting of animal hides, vinyl, and fabrics made from synthetic or natural fibers.

13. The protective garment according to claim 12, wherein the exterior layer comprises leather.

14. The protective garment according to claim 12, wherein the garment comprises said second interior layer and said second interior layer comprises at least one member selected from the group consisting of latex, animal hides, animal furs, cotton, rayon, silk, polyester, and nylon.

15. The protective glove according to claim 12, further comprising at least one adhesive layer adhering two or more of the exterior, first interior, and second interior layers.

16. The protective garment according to claim 13, wherein the garment comprises said second interior layer and said second interior layer comprises at least one member selected from the group consisting of latex, animal hides, animal furs, cotton, rayon, silk, polyester, and nylon.

17. The protective garment according to claim 16, further comprising at least one adhesive layer adhering two or more of the exterior, first interior, and second interior layers.

18. A covered container article, comprising:
a container having a covering on an external surface thereof, wherein said covering comprises a reinforced multilayer material as claimed in claim 1.

19. The covered container article according to claim 18, wherein the exterior layer comprises at least one member selected from the group consisting of animal hides, vinyl, and fabrics made from synthetic or natural fibers.

20. The covered container article according to claim 19, wherein the exterior layer comprises leather.

21. The covered container article according to claim 19, further comprising at least one adhesive layer adhering the exterior layer and first interior layer to one another.

22. The covered container article according to claim 19, wherein said article is an article of luggage or a handbag.
